(19) United States
(12) Patent Application Publication
(10) Pub. No.: US 2016/0018751 A1
(43) Pub. Date: Jan. 21, 2016

(54) ROLLER, METHOD FOR MANUFACTURING SAME AND IMAGE FORMING DEVICE USING SAME

(71) Applicant: BRIDGESTONE CORPORATION, Tokyo (JP)

(72) Inventors: Shogo IMAI, Yokohama-shi (JP); Yusuke FUJISAWA, Yokohama-shi (JP); Yusuke KAMIJO, Yokohama-shi (JP)

(73) Assignee: BRIDGESTONE CORPORATION, Tokyo (JP)

(21) Appl. No.: 14/771,248

(22) PCT Filed: Mar. 5, 2014
(86) PCT No.: PCT/JP2014/055600

§ 371 Date: Aug. 28, 2015

(30) Foreign Application Priority Data
May 3, 2013 (JP) 2013-042577`

(51) Int. Cl. G03G 15/08; B21D 53/00; F16C 13/00

(52) U.S. Cl. CPC G03G 15/00

(57) ABSTRACT

Provided are a roller capable of suppressing the generation of cutting waste from the cut surface of a foam layer at the end of the roller in the axial direction thereof, a method of manufacturing especially a conductive roller, and an image forming device using the roller. The roller is provided with a shaft 1, and a foam layer 2 and at least one film layer 3, sequentially provided on the outer periphery of the shaft. The foam layer and film layer are cut at both ends of the roller in the axial direction thereof, and a filler layer 4 for covering at least the foam layer is provided on the cut surface of the foam layer and film layer.

### TECHNICAL FIELD

The present invention relates to a roller, a method for manufacturing thereof and an image formation device using thereof, and in particular, to a conductive roller used in image formation devices such as copying machines, printers and in particular laser beam printers, and in particular to a roller suitable as a developing roller, a method for manufacturing thereof and an image formation device using thereof.

### BACKGROUND ART

In general, in image formation devices using electrophotographic printing methods such as copying machines, printers, facsimiles, etc., rollers provided with electrical conductivity are used such as transfer rollers, developing rollers, toner supply rollers, electrification rollers, cleaning rollers, intermediate transfer rollers, belt driving rollers, etc. in each step of the image formation.

As such a roller member, in order to obtain desired surface roughness, electrical conductivity and hardness etc., conventionally used is one that are provided with a layer or layers provided on the outer periphery of a basic structure which is a structure constituted by shaft on which an elastic layer is formed, the elastic layer being composed of rubber, polymeric elastomer, polymer foam, etc. which was given electrical conductivity by the combination of a conductive agent.

As a technology relating to the improvement of the conductive roller, for example, Patent document 1 describes a conductive roller having a core metal, a substrate provided on the surface thereof and a filler layer provided on the cylindrical surface of the substrate which is composed of conductive flexible polyurethane foam, wherein a release opening for a bubble of conductive flexible polyurethane foam in the cylindrical surface is blocked by the filler layer.

### RELATED ART DOCUMENT

### Patent Document

Patent Document 1: Japanese Unexamined Patent Publication No. H9-262912 (Claims etc.)

### SUMMARY OF THE INVENTION

### Problems to be Solved by the Invention

However, when the elastic layer supported on the outer periphery of the shaft is formed by a foam layer and the end of the shaft is cut in its axial direction in order to adjust the roller size and shape, cut waste is sometimes generated from the end of the foam layer exposed due to cutting. Such cut waste, if transferred to photo sensitizer or paper in an image formation device, is problematic due to the occurrence of an image defect. Although, for dealing with the problem, methods of air spraying and wipe spraying treatment may be used to remove cut waste, they cannot remove it completely.

Accordingly, an object of the present invention is to dissolve the above-mentioned problem and provide a roller suppressing the generation of cut waste from cut surface of a foam layer at the end of the roller in the axial direction thereof, especially a conductive roller, a method of manufacturing thereof and an image forming device using thereof.

### Means for Solving the Problems

After intensive considerations, the inventors have found that providing a filler layer on the cut surface of the end part of the roller subjected to cutting treatment can solve the above-mentioned problem, and have accomplished the present invention.

In other words, in a roller provided with a shaft, a foam layer and at least one film layer, sequentially provided on the outer periphery of the shaft, the roller of the present invention is characterized in that

the above-mentioned foam layer and the above-mentioned film layer are cut at both ends of the roller in the axial direction thereof, and that a filler layer for covering at least the foam layer is provided on the cut surfaces of the cut foam layer and the cut film layer.

In the roller of the present invention, the above-mentioned filler layer preferably comprises a liquid adhesive or a hot-melt adhesive. Further, in the roller of the present invention, the above-mentioned foam layer suitably comprises polyurethane foam, and in particular, the density of the above-mentioned polyurethane foam is preferably within the range from 0.1 to 0.7 g/cm³. Still further, the roller of the present invention is suitably a conductive roller.

In addition, the method of manufacturing the roller of the present invention is characterized by, when manufacturing the roller of the above present invention,

forming the above-mentioned foam layer by molding, forming by coating at least one film layer on the outer periphery of the formed foam layer, and cutting the formed foam layer and the film layer at the both ends of the roller in the axial direction thereof followed by providing the above-mentioned filler layer on the cut surface of the cut foam layer and the cut film layer so as to cover at least the foam layer.

Furthermore, the image forming device of the present invention is characterized in that the above roller of the present invention is mounted thereon.

### Effects of the Invention

According to the present invention, the above-mentioned constitution can suppress the generation of cut waste from the cut surface of the foam layer at the end of the roller in the axial direction thereof, thereby enabling a roller that can prevent the occurrence of an image defect due to cut waste, a method of manufacturing the roller, and an image forming device using the roller.

### BRIEF DESCRIPTION OF THE DRAWINGS

FIG. 1 is a longitudinally cross-sectional view of one constitutional example of the roller of the present invention.

FIG. 2 is a partial cross-sectional view of one constitutional example of the image forming device of the present invention.

### MODE FOR CARRYING OUT THE INVENTION

An embodiment of the present invention will now be described with reference to the drawings.

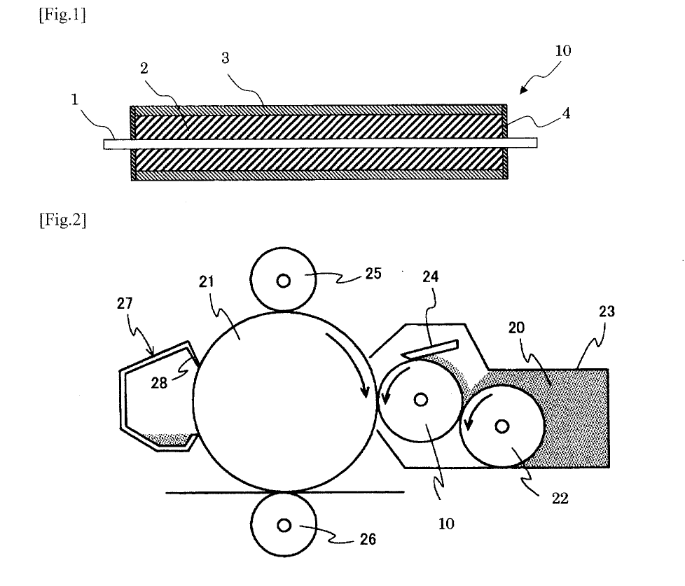

FIG. 1 depicts a longitudinally cross-sectional view of an example of a roller of the present invention. As depicted, the roller 10 of the present invention is provided with a shaft 1, a foam layer 2 supported on the outer periphery of the shaft and at least one film layer covering the outer periphery of the foam layer which is a film layer 3 in the illustrated example.

The roller of the present invention is characterized in that foam layer 2 and the at least one film layer 3 are cut at the both ends of the roller in the axial direction thereof, a filler layer 4 covering the at least foam layer 2 is provided on the cut surface of the foam layer 2 and the at least one film layer 3 which were cut. By providing on the cut surface the filler layer 4 covering at least the foam layer 2 and eliminating the exposure of the cut surface of the foam layer 2, the occurrence of cut waste from the cut surface has enabled to be effectively suppressed. This enables preventing the occurrence of an image defect caused by the attachment of cut waste onto photo sensitizer, etc. in image forming devices.

The filler layer 4 may be formed from any material so long as it can cover the cut surface at least of the foam layer 2, and thereby an effect to suppress the occurrence of cut waste can be obtained. Washers etc. as well as liquid adhesives and hot-melt adhesives can be specifically used, for example. In particular, hot-melt adhesives are suitable for easiness to form a filler layer. Liquid adhesives include single-liquid or two-liquid solvent-based types, solvent-free types or water-based types, and the material types include urethane, acryl, vinyl acetate, epoxy, silicon, synthetic rubber, and when polyurethane foam is used for a foam layer, urethane and synthetic rubber are suitable among others regarding flexibility, affinity, etc. In this case, for example, a dispenser, a stamp, a spray, a knife coater, etc. can be used to apply the liquid adhesive, and then the filler layer 4 can be formed by volatilization hardening, heating hardening or ultraviolet curing, etc. The coating methods specifically include methods of scraping off by a doctor knife etc. paint applied onto the cut surface by a dispenser etc. and of spray-coating the cut surface, and as for a heating method, conventional procedures may be used as required.

The hot-melt adhesive is a sheet-like adhesive, the material types of which include polyurethane, vinyl acetate, polyolefin, synthetic rubber, and when polyurethane foam is used for a foam layer, urethane and synthetic rubber are suitable among others regarding flexibility, affinity, etc. In this case, the filler layer 4 can be formed by applying heat press, radio frequency, supersonic wave, etc., for example, to the hot-melt adhesive which was cut into a shape corresponding to the cut surface and is kept in contact to the cut surface. In the case of washers, one made from widely used metals such as stainless steel and aluminum, and from widely used resins such as polypropylene (PP) and polyamide (PA66, PA6, PA12), etc. can be used, and it can be fit into the shaft or adhered to the cut surface by adhesive to form the filler layer 4. As an adhesive used in this case, general instantaneous adhesives for metal and resin are preferable regarding process time, and for example, Aron Alpha (registered trademark) (for general use) can be used. The coating methods thereof, for example, include methods of applying the adhesive onto the cut surface as spots by a dispenser (spot gluing) and of scraping by a doctor knife etc. paint supplied onto the cut surface by a dispenser etc. (adhesion of whole area).

Since the filler layer 4 is acceptable so long as it can cover at least the cut surface of the foam layer 2, the filler layer 4 may be formed into the same diameter as that of the roller or a diameter larger than or equal to the outer diameter of the foam layer 2 and smaller than that of the roller. The filler layer 4 may be formed specifically, for example, into an outer diameter of [(outer diameter of the roller)−0 μm˜(outer diameter of the roller)−250 μm] although it depends on the roller size. Since the thickness of the filler layer 4 is acceptable so long as the filler layer 4 is sufficiently thick to cover completely the cut surface of the foam layer 2, the thickness can be, for example, about 120 μm or less for a coating film etc.

In the present invention, the only important point is that in a roller having a cut surface of a foam layer at the end of the roller in the axial direction thereof, at least the cut surface of the foam layer was covered by a filler layer, and otherwise the constitution may be made appropriately according to conventional methods and is not particularly limited.

For example, the shaft 1 is not limited so long as it is well electro-conductive, and any shafts can be used, which, for example, include solid core metals made from steel metals such as sulfur free cutting steel plated by nickel or zinc, etc., of iron, stainless steel, aluminum, etc., metal shafts such as a hollow metal cylindrical body etc., and shafts made from well electro-conductive plastics.

The foam layer 2 is composed from foam, specifically for example, made from elastomer such as polyurethane, silicone rubber, ethylene-propylene-diene rubber (EPDM), acrylonitrile-butadiene rubber (NBR), natural rubber, styrene-butadiene rubber (SBR), butadiene rubber, isoprene rubber, polynorbornene rubber, butyl rubber, chloroprene rubber, acrylic rubber, epichlorohydrin rubber (ECO), ethylene-vinyl acetate copolymer (EVA) and the mixture thereof, and is suitably composed of polyurethane foam. The foam constituting the foam layer 2 is formed by foaming chemically the above-mentioned elastomer with a foaming agent or by foaming it mechanically by involving air therein as in the case of polyurethane foam.

In addition, since compression permanent deformation performance is improved when the foam constituting the foam layer 2 is a closed-cell foam, bubbles in the foam are suitably closed-cell bubbles. In order for bubbles in the foam to be closed-cell, the procedure of foaming the above-mentioned elastomeric raw material by mechanical stirring of the foam is suitably adopted.

Raw polyurethane materials for forming the polyurethane foam which are suitably used for the foam layer 2 are not especially limited so long as they contain a urethane bond in the resin. As a polyisocyanate constituting the raw polyurethane material, aromatic isocyanate or the derivative thereof, aliphatic isocyanate or the derivative thereof, and alicyclic isocyanate or the derivative thereof are used. Aromatic isocyanate or the derivative thereof is preferable among them, and tolylenediisocyanate or the derivative thereof, and diphenylmethane diisocyanate or the derivative thereof are particularly suitably used. As tolylenediisocyanate or the derivative thereof, crude tolylenediisocyanate, 2,4-tolylenediisocyanate, 2,6-tolylenediisocyanate, the mixture of 2,4-tolylenediisocyanate and 2,6-tolylenediisocyanate, the urea modified products thereof, the burette modified products thereof, the carbodiimide modified products thereof, and urethane product modified by polyol etc. are used. As diphenyl methane diisocyanate or the derivative thereof, for example, diphenylmethane diisocyanate or the derivative thereof, obtained by phosgenation of diaminodiphenylmethanes or the derivative thereof are used. The derivatives of diaminodiphenylmethane, include polynuclear products, and pure diphenylmethane diisocyanate obtained from diaminodiphenylmethane, polymeric diphenylmethane diisocyanates obtained from the polynuclear products of diaminodiphenylmethane can be used. As for the number of functional groups of polymeric diphenylmethane diisocyanate, a mixture of pure diphenylmethane diisocyanate and polymeric diphenyl methane diisocyanate having various numbers of functional groups is usually used, and a mixture having an averaged number of functional groups preferably from 2.05 to 4.00, more preferably from 2.50 to 3.50 are used. In addition, derivatives obtained by the modification of these diphenylmethane diisocyanates or derivatives thereof, for example, such as urethane modification products modified by polyol etc., dimers by uretdione formation, isocyanurate modification products, carbodiimide/uretonimine modification products, allophanate modification products, urea modification products, burette modification products can be also used. Further, a blend of several kinds of diphenylmethane diisocyanates and the derivatives thereof can be also used.

Polyol components constituting raw polyurethane materials can be used which include polyether polyol from the addition polymerization of ethylene oxide with propylene oxide, polytetramethylene ether glycol, polyester polyol from the condensation of the acid component and the glycol component, polyester polyol from the ring-opening polymerization of caprolactone, and polycarbonate diol. Polyether polyol from the addition polymerization of ethylene oxide with propylene oxide include products from the addition polymerization of ethylene oxide with propylene oxide, for example, by using, as a starting material, water, propylene glycol, ethylene glycol, glycerin, trimethylolpropane, hexane triol, triethanolamine, diglycerine, pentaerythritol, ethylenediamine, methyl glucoside, aromatic diamine, sorbitol, sucrose, phosphoric acid, etc., and particularly suitable is a product from water, propylene glycol, ethylene glycol, glycerin, trimethylolpropane, hexane triol used as a starting material. As for the ratio and microstructure of added ethylene oxide and propylene oxide, the ratio of ethylene oxide is preferably from 2 to 95% by mass, more preferably from 5 to 90% by mass. In particular, the polyether polyol having ethylene oxide added on the terminal thereof is preferably used. The arrangement of ethylene oxide and propylene oxide in the molecular chain is preferably random. The molecular weight of this polyether polyol, bifunctional when obtained from water, propylene glycol and ethylene glycol as starting materials, is preferably in the range from 300 to 6000 by weight-average molecular weight, particularly preferably from 400 to 3000. The molecular weight of the polyether polyol, trifunctional when obtained from glycerin, trimethylolpropane and hexane triol as starting materials, is preferably in the range from 900 to 9000 by weight-average molecular weight, and particularly preferably from 1500 to 6000. A blend of the bifunctional polyol and the trifunctional polyol can be appropriately used.

Polytetramethylene ether glycol is obtained, for example, from cationic polymerization of tetrahydrofuran, and the product having weight-average molecular weight in the range from 400 to 4000, particularly from 650 to 3000 is preferably used. It is also preferable to blend polytetramethylene ether glycols with different molecular weights. In addition, polytetramethylene ether glycols obtained from copolymerization of alkylene oxides such as ethylene oxide and propylene oxide can be also used. It is also preferable to use a blend of polytetramethylene ether glycol and polyether polyol from addition polymerization of ethylene oxide with propylene oxide, and in this case, it is preferably used so that the ratio of polytetramethylene ether glycol to polyether polyol from addition polymerization of ethylene oxide with propylene oxide is within the range from 95:5 to 20:80 by mass, and particularly from 90:10 to 50:50. Polymer polyol of acrylonitrile-modified polyol, polyol of melamine added to polyol, diols such as butane diol, polyols such as trimethylolpropane and the derivatives thereof can be used in combination with the above-mentioned polyol components.

Polyol may be prepolymerized by polyisocyanate in advance, and the methods include a method in which polyol and polyisocyanate are put into a suitable vessel, sufficiently stirred and kept at 30 to 90° C., more preferably 40 to 70° C., for 6 to 240 hours, more preferably for 24 to 72 hours. In this case, the ratio of the quantities of polyol and polyisocyanate are preferably adjusted so that the isocyanate content ratio of the prepolymer to be obtained is from 4 to 30% by mass, more preferably from 6 to 15% by mass. If the isocyanate content ratio is less than 4% by mass, the stability of the prepolymer is damaged, and the prepolymer may be hardened during storage and not be able to be provided for use. When the isocyanate content ratio exceeds 30% by mass, polyisocyanate content that has not been prepolymerized increases, and since this polyisocyanate is hardened with polyol component to be used in a later polyurethane hardening reaction, via a reaction mechanism similar to a one-shot process that does not undergo prepolymerization reaction, the advantage of the prepolymer method is diminished. As polyol components, when isocyanate component is used which is in prepolymer of polyol prepolymerized in advance by polyisocyanate, diols such as ethylene glycol and butane diol, polyols such as trimethylolpropane and sorbitol, and the derivatives thereof can be used in addition to the above-mentioned polyol components.

To the raw polyurethane material can be added a conductive agent such as an ionic conducting agent and an electro-conductive agent, a filler material such as carbon black and inorganic carbonate, an antioxidant such as phenol and phenylamine, a friction-reducing agent, and a charge adjustment agent, etc. Examples of the ionic conducting agent include ammonium salts such as perchlorate, chlorate, hydrochloride, bromate, iodate, fluoroborate, sulfate, ethylsulfonate, carboxylate, sulfonate of tetraethylammonium, tetrabutylammonium, dodecyltrimethylammonium (for example, lauryl trimethyl ammonium), hexadecyl trimethyl ammonium, octadecyl trimethyl ammonium (for example, stearyl trimethyl ammonium), benzyl trimethyl ammonium, modified fat dimethylethyl ammonium, etc., and perchlorate, chlorate, hydrochloride, bromate, iodate, fluoroborate, trifluoromethylsulfonate, sulfonate of alkali and alkaline earth metals such as lithium, sodium, potassium, calcium, magnesium. Examples of the electro-conductive agent include conductive carbons such as Ketjen black, acetylene black; carbons for rubber such as SAF, ISAF, HAF, FEF, GPF, SRF, FT, MT; oxidation-treated carbon for ink, thermal decomposition carbon, natural graphite, artificial graphite; electro-conductive metal oxides such as tin oxide, titanium oxide, zinc oxide; metals such as nickel, copper, silver, germanium. These conductive agents may be used alone or in a mixture of more than or equal to two of them. The blending quantity thereof is not particularly limited and can be appropriately selected as desired, and the ratio is usually from 0.1 to 40 parts by mass, preferably from 0.3 to 20 parts by mass with respect to 100 parts by mass of the raw polyurethane material.

Catalysts used in the hardening reaction of the raw polyurethane materials include monoamines such as triethylamine and dimethyl cyclohexylamine, diamines such as tetramethylethylene diamine, tetramethyl propane diamine and tetramethyl hexane diamine, triamines such as pentamethyldiethylene triamine, pentamethyldipropylene triamine, tetra-methylguanidine, cyclic amines such as triethylenediamine, dimethyl piperazine, methylethyl piperazine, methyl morpholine, dimethylaminoethyl morpholine, dimethyl imidazole, alcoholic amines such as dimethylamino ethanol, dimethylaminoethoxy ethanol, trimethylaminoethylethanol amine, methylhydroxyethyl piperazine, hydroxyethyl morpholine, ether amines such as bis(dimethylaminoethyl)ether, ethylene glycol bis(dimethyl)amino propyl ether, and organometallic compounds such as stannous octoate, dibutyl tin diacetate, dibutyl tin dilaurate, dibutyl tin mercaptide, dibutyl tin thiocarboxylate, dibutyl tin dimaleate, dioctyl tin mercaptide, dioctyl tin thiocarboxylate, phenyl mercury propionate, lead octenoate. These catalysts can be used alone or in combination of two or more of them.

In the present invention, it is preferable that a silicone foam stabilizer and various surfactants are combined into the raw polyurethane materials for stabilizing the cells in the foam material. As the silicone foam stabilizer, dimethylpolysiloxane-polyoxyalkylene copolymer, or the like is suitably used, and particularly preferable is the copolymer having the dimethylpolysiloxane moiety of molecular weight from 350 to 15000 and the polyoxyalkylene moiety of molecular weight from 200 to 4000. As for the molecular structure of the polyoxyalkylene moiety, the addition polymer of ethylene oxide and the co-addition polymer of ethylene oxide and propylene oxide are preferable, and the molecular terminals of the polymers are also preferably ethylene oxide. The surfactants include ionic surfactants such as cationic surfactants, anionic surfactants and amphoteric surfactants, and non-ionic surfactants such as various polyethers and various polyesters. The blending quantities of the silicone foam stabilizer and the various surfactants are preferably from 0.1 to 10 parts by mass, more preferably from 0.5 to 5 parts by mass to 100 parts by mass of the raw polyurethane material.

The polyurethane foam used in the present invention preferably has a density within the range from 0.1 to 0.7 g/cm³, more preferably from 0.50 to 0.65 g/cm³. In particular, when polyurethane foam is used which has a low density roughly within these ranges, cut waste is likely to occur, and the application of the present invention is effective. Too low and too high densities are both undesirable because the too low density leads to the coarsening of the bubble, and the too high density leads to the worsening of roller performance.

The ASKER C hardness of the polyurethane foam is preferably from 15 to 70°, more preferably from 15 to 45°. In the present invention, the mechanical floss method, the water foaming method, the foaming agent floss method, etc., which are conventionally used, can be used as a method of foaming in advance the raw polyurethane material, and the mechanical floss method, which performs foaming by mechanical stirring while mixing inactive gas, is preferably used regarding obtaining polyurethane foam of the closed-cell foam structure having a suitable density and hardness. Any inactive gasses used in the mechanical floss method are acceptable so long as they are inactive gas in polyurethane reaction, and include gasses non-reactive to the raw polyurethane materials such as nitrogen, carbon dioxide and dry air as well as inactive gasses in a narrow sense such as helium, argon, xenon, radon and krypton. By injecting the foamed raw polyurethane material into a metal mold, followed by the hardening thereof, polyurethane foam can be obtained which has self-skin layer (thin stratified film) formed on the part of the foam in contact to the metal mold. At that time, a method of coating with fluoro-resin etc. the inner surface of the metal mold can give mold-releasing property to the metal mold.

The molding conditions of the foam layer 2 is not particularly limited and can be obey usually conditions, and for example, the foam layer 2 can be obtained by starting the foaming of the raw polyurethane material at a temperature within the range from 15 to 80° C., preferably from 20 to 65° C., and completing injection into the metal mold in which shaft 1 is placed, and then performing cure at a temperature from about 70 to 120° C., followed by removal of the product from the mold.

In the present invention, at least one film layer is formed on the outer periphery of the foam layer 2. Although in an example depicted in FIG. 1 one film layer 3 as a surface layer forming a roller surface is provided on the outer periphery of the foam layer 2, two film layers of an intermediate layer and a surface layer can be also provided without limitation, and moreover, other functional layers may be added.

For example, the surface layer can be formed by solvent-based paints such as urethane-based, acrylic-based, acrylic urethane-based and fluorine-based ones, and the surface roughness of the layer can be adjusted by containing spherical microparticles made of urethane, acryl, silica, etc. The surface roughness of such a surface layer is usually less than or equal to 2 μm, particularly preferably within the range from 0.5 to 1.5 μm based on the JIS arithmetic average roughness Ra. Desired electrical conductivity can be given by appropriately containing the above-mentioned ionic conductive agent and the electron conductive agent as a conductive agent. Although the thickness of the surface layer is not particularly limited, it may be usually from 1 to 50 μm, particularly from about 1 to about 40 μm.

The intermediate layer may be a water-based paint containing a conductive agent, and any one or at least two types selected from the group consisting of rubber-based, urethane-based and acrylic-based paints can be suitably used as the water-based paint. Latex such as natural rubber (NR), chloroprene rubber (CR), nitrile rubber (NBR) and styrene-butadiene rubber (SBR) can be appropriately used as the rubber-based paint, ether-based, ester-based emulsions and dispersions as the urethane-based paint, and acryl, acrylic styrene emulsions etc. as the acrylic-based paint. The same conductive agents as those mentioned above with respect to the foam layer 2 can be used as conductive agents contained in the paints without particular limitation. In addition, vulcanizers, vulcanization enhancers, rubber antioxidants, and the like can be appropriately added to the intermediate layer as desired.

The thickness of the intermediate layer is usually within the range from 10 to 100 μm, particularly from 30 to 80 μm. When the thickness is less than 10 μm, the solvent shielding effect for the foam layer and the filler effect for preventing oozing of contaminant from the lower layer side become insufficient, resulting in solvent erosion that makes impossible to provide a desired surface roughness. On the other hand, when the thickness exceeds 100 μm, the intermediate layer cannot follow the softness of the foam layer 2, causing a crack and a peeling, the hardening of the roller itself, which could lead to a defect relating to the roller performance such as toner damage.

The intermediate layer can be formed into one or at least two layers by applying the above-mentioned water-based paint onto foam layer 2. Well-known procedures can be used as methods of coating the intermediate layer, which include, but are not limited to, dip coating, spray coating and roll-coater coating, and dip coating is suitably used. The micro hardness of the intermediate layer is suitably within the range from 10 to 45° for the film thickness of 500 μm, and the hardness roughly within this range can realize desired roller hardness for the finally obtained roller surface. The micro hardness can be measured, for example, by Micro Durometer Model MD-1.

The roller of the present invention is suitable as a conductive roller used in electrophotographic image forming devices etc. and can be suitably used specifically, for example, as various roller members such as developing rollers, electrification rollers, transfer rollers, toner supply rollers and cleaning rollers, and is particularly useful as a developing roller.

The roller of the present invention can be manufactured as follows: At first, a foam layer is formed on the outer periphery of a shaft by molding; Then, at least one film layer, specifically for example, the above-mentioned surface layer is directly formed, or an intermediate layer and the surface layer are sequentially formed by coating on the formed foam layer; Then, the formed foam layer and the film layer are cut at the both ends of the roller in the axial direction thereof, wherein cases of cutting the foam layer and the film layer at the both ends of the roller in the axial direction thereof include a case of cutting the end parts of the roller expanded by molding and a case of adjusting the size of the roller from the view point of the appearance of the roller; Then, by the above-mentioned various techniques, the filler layer in a size enough to cover at least the foam layer is provided on the cut surfaces of the cut foam and film layers, and thus the roller of the present invention can be obtained.

Further, the image forming device of the present invention is characterized in that the roller of the above present invention, especially the conductive roller, the developing roller among others is mounted thereon, thereby enabling to solve the problem of the occurrence of an image defect due to the attachment of cut waste onto photo sensitizer etc. FIG. 2 depicts a partial cross-sectional view of an example of the image forming device of the present invention. In the illustrated image forming device of the present invention, there are provided an image forming body 21, such as photo sensitizer, retaining an electrostatic latent image, a developing roller 10, in contact to the image forming body 21, for visualizing the electrostatic latent image by the adhesion of toner 20 supported on the surface of the roller thereto, and a toner supply roller 22 for supplying the toner 20 to the developing roller 10, and image formation is performed by a series of processes which convey the toner 20 from a toner container 23 via the toner supply roller 22 and the developing roller 10 to the image forming body 21.

In the illustrated image forming device, the image forming body 21 is electrified to a constant potential by an electrification roller 25, and then, an electrostatic latent image is formed on the image forming body 21 by an exposure device (not illustrated). Then, by the rotation of the toner supply roller 22, the developing roller 10 and the image forming body 21 in the direction of the arrow in the figure, the toner 20 on toner supply roller 22 is sent via the developing roller 10 to the image forming body 21. The toner 20 on the developing roller 10 is shaped into a uniform thin layer by a layering blade 24, and by the rotation of the developing roller 10 and the image forming body 21 in contact with each other, the toner 20 from developing roller 10 adheres to the electrostatic latent image in the image forming body 21, resulting in the visualization of the latent image. The toner 20 adhering to the latent image is transferred by the transfer roller 26 to recording medium such as paper, and the toner 20 remaining on the image forming body 21 after the transfer is removed by a cleaning blade 28 in a cleaning part 27. The image formation device of the present invention may be further provided with well-known compartments (not illustrated) used in conventional image forming devices.

### EXAMPLES

The present invention will now be described in detail by using Examples.

First of all, polyurethane foam was supported on the outer periphery of a shaft (φ8 mm, 260 mm in length, material type: sulfur free cutting steel) by the mechanical floss method. The density of this polyurethane foam was 0.60 g/cm³.

In particular, a raw polyurethane material composed of an isocyanate component (prepolymerized isocyanate TDI+polyether polyol) of 100 parts by mass and a polyol component (polyether polyol) of 20 parts by mass, carbon-black (acetylene black) of 2 parts by mass, an ionic conducting agent (sodium perchlorate) of 0.2 parts by mass was prepared, and this raw polyurethane material was mechanically stirred, mixed with dry air by mixier, and foamed. The polyurethane-foam material was injected into a metal cylindrical split mold which was provided with a hole provided at the end thereof for penetrating the shaft and a metal cap placed for supporting the shaft. Inside the mold, the shaft was placed, with adhesive applied onto the outer periphery thereof. Then, the mold with polyurethane-foam material injected therein was left in a hot wind oven adjusted to be at 110° C. for one hour to allow the polyurethane-foam material to harden.

The hardened polyurethane foam was released from the mold and dip-coated with CR rubber latex paint combined with carbon black (Ketjen black) to form an intermediate layer of a film thickness of 60 μm on the outer periphery of the foam layer. Then, the foam was dip-coated with polyurethane solvent-based paint combined with spherical polyurethane particles of D⁵⁰=10 μm and carbon black (acetylene black) to form a surface layer of a film thickness of 15 μm.

The roller body of the roller obtained above was cut at both ends of the roller in the axial direction thereof so that the size of the roller body was φ 11.5 mm and 240 mm in length. Then, on the cut surface of the roller body, each of the filler layers described in the following Tables 1 to 3 was formed to obtain the sample rollers of Examples 1 to 12. When liquid adhesives were used, the filler layers were formed within the cut surface of φ 11.5 mm by spray-coating followed by heating. When hot-melt adhesives were used, the sheet-shaped adhesives were cut into a ring shape of an outer diameter of φ 11.5 mm to be attached and welded by heat-press, to form the filler layers. Further, when washers were used, the washers of an outer diameter of φ 11.5 mm made from metal (stainless steel) and made of resin (PP) were attached by an adhesive (Aron Alpha (registered trademark) (for general use)) applied as dots on the cut surface by dispenser to form the filler layers. In addition, a roller having no filler layer formed on the cut surface of the roller body was treated as the example of a conventional sample roller.

### <Evaluation Method>

The resulting each sample roller was incorporated into a commercially available laser beam printer (Cannon Inc., LBP7200C) and subjected to a printing durability test that performs a hundred sheets of printing. The results were evaluated by visual inspection of the printed image with respect to the existence or non-existence of an image defect caused by cut waste from the cut surface (non-existence of defect is represented by “◯”, and the existence of fault “x”) and of defect such as the peeling of the adhesive in the filler layer after the printing test. The results are collectively described in the following Tables 1 to 3.

TABLE 1

| | Conventional | | | | |
|---|---|---|---|---|---|
| | example | Example 1 | Example 2 | Example 3 | Example 4 |
| material of | — | liquid adhesive | liquid adhesive | liquid | liquid adhesive |
| filler layer | | | | adhesive | |
| material type | — | urethane-based*¹ | synthetic | acryl-based*³ | vinyl-acetate-based*⁴ |
| | | | rubber-based*² | | |
| existence or | X | ◯ | ◯ | ◯ | ◯ |
| non-existence | | | | | |
| of image | | | | | |
| defect due to | | | | | |
| cut waste | | | | | |
| existence or | — | No | No | No | No |
| non-existence | | | | | |
| of peeling of | | | | | |
| adhesive | | | | | |

*¹UM 700, Cemedine Co., Ltd.
*²575, Cemedine Co., Ltd.
*³Y610, Cemedine Co., Ltd.
*⁴CH38, Konishi Co., Ltd.

TABLE 2

| | Example 5 | Example 6 | Example 7 | Example 8 |
|---|---|---|---|---|
| material of | liquid | liquid | hot-melt | hot-melt |
| filler layer | adhesive | adhesive | adhesive | adhesive |
| material type | epoxy- | silicon- | urethane- | vinyl-acetate- |
| | based*⁵ | based*⁶ | based*⁷ | based*⁸ |
| existence or | ◯ | ◯ | ◯ | ◯ |
| non-existence | | | | |
| of image defect | | | | |
| due to cut | | | | |
| waste | | | | |
| existence or | No | No | No | No |
| non-existence | | | | |
| of peeling of | | | | |
| adhesive | | | | |

*⁵EP007, Cemedine Co., Ltd.
*⁶SILIMATE 82, TOSHIBA CORPORATION
*⁷Ecellent (50 μm in thickness), Sheedom Co., Ltd.
*⁸HM 224 (50 μm in thickness), CEMEDINE Co., Ltd.

TABLE 3

| | Example 9 | Example 10 | Example 11 | Example 12 |
|---|---|---|---|---|
| material of | hot-melt | hot-melt | washer | washer |
| filler layer | adhesive | adhesive | | |
| material type | polyolefin- | Synthetic | metal | metal |
| | based*⁹ | rubber- | | |
| | | based*¹⁰ | | |
| existence or | ◯ | ◯ | ◯ | ◯ |
| non-existence | | | | |
| of image defect | | | | |
| due to cut | | | | |
| waste | | | | |
| existence or | No | No | No | No |
| non-existence | | | | |
| of peeling of | | | | |
| adhesive | | | | |

*⁹HM712 (50 μm in thickness), Cemedine Co., Ltd.
*¹⁰HM 650-2 (50 μm in thickness), Cemedine Co., Ltd.

As can be seen in the above Tables 1 to 3, it was confirmed that by providing, on the cut surface of the roller body, the filler layer covering at least the foam layer, the occurrence of an image defect caused by cut waste can be effectively prevented, and that other problems such as peeling of the filler layer at the time of use do not occur.

The rollers were fabricated in the same manner as the Embodiment 1 except that the densities of polyurethane foam constituting the foam layers were changed to those described in the following Table 4, and the roller body was cut at both ends of the roller in the axial direction thereof into a size of φ 11.5 mm and 240 mm in length. Then, the filler layers described in the following Table 4 were formed on the cut surface of the roller body in the same manner as Example 1, and the sample rollers of Examples 13 to 18 were obtained. Each of the resulting sample rollers was evaluated in the same manner as Example 1 etc., and the evaluation results are collectively described in the following Table 4.

TABLE 4

| | Example 13 | Example 14 | Example 15 | Example 16 | Example 17 | Example 18 |
|---|---|---|---|---|---|---|
| density of polyurethane | 0.45 | 0.5 | 0.55 | 0.6 | 0.65 | 0.7 |
| foam (g/cm³) | | | | | | |
| material of filler layer | liquid adhesive | liquid adhesive | liquid adhesive | liquid adhesive | liquid adhesive | liquid adhesive |
| material type | urethane-based*¹ | urethane-based*¹ | urethane-based*¹ | urethane-based*¹ | urethane-based*¹ | urethane-based*¹ |
| existence or non-existence | ◯ | ◯ | ◯ | ◯ | ◯ | ◯ |
| of image defect due to | | | | | | |
| cut waste | | | | | | |
| existence or non-existence | No | No | No | No | No | No |
| of peeling of adhesive | | | | | | |

As can be seen in the Table 4, it was confirmed that even when the density of the polyurethane foam constituting the foam layer was changed, by providing, on the cut surface of the roller body, the filler layer covering at least the foam layer, the occurrence of an image defect caused by cut waste can be prevented without the occurrence of other problems such as peeling of the filler layer at the time of use.

### DESCRIPTION OF SYMBOLS

1 shaft
2 foam layer
3 film layer
4 filler layer
10 roller (developing roller)
20 toner
21 image forming body
22 toner supply roller
23 toner container
24 layering blade
25 electrification roller
26 transfer roller
27 cleaning part
28 cleaning blade

1. A roller provided with a shaft, a foam layer and at least one film layer, sequentially provided on the outer periphery of the shaft, characterized in that
the foam layer and the film layer are cut at the both ends of the roller in the axial direction thereof, and a filler layer for covering at least the foam layer is provided on the cut surface of the cut foam layer and the cut film layer.

2. The roller according to claim 1, wherein the filler layer comprises liquid adhesive or hot-melt adhesive.

3. The roller according to claim 1, wherein the foam layer comprises polyurethane foam.

4. The roller according to claim 3, wherein the density of the polyurethane foam is within the range from 0.1 to 0.7 g/cm³.

5. The roller according to claim 1 which is a conductive roller.

6. A method for manufacturing the roller according to claim 1, characterized by:
forming the foam layer by molding; forming, by coating, at least one film layer on the outer periphery of the formed foaming layer; and cutting the formed foam layer and film layer at the both ends of the roller in the axial direction thereof, followed by providing the filler layer on the cut surface of the cut foam layer and the cut film layer so as to cover at least the form layer.

7. An image forming device characterized in that the roller according to claim 1 is mounted thereon.
